(19) United States
(12) Patent Application Publication
(10) Pub. No.: US 2016/0251745 A1
(43) Pub. Date: Sep. 1, 2016

(54) DEVICE FOR HVOF SPRAYING PROCESS

(71) Applicant: GENERAL ELECTRIC TECHNOLOGY GMBH, Baden (CH)

(72) Inventors: Sven OLLIGES, Duebendorf (CH); Jeton NIVOKAZI, Birrhard (CH); Benjamin-Timo ZOLLER, Dietlikon (CH); Uwe HAARNAGEL, Egliswil (CH); Weiqun GENG, Baden-Daettwil (CH)

(73) Assignee: GENERAL ELECTRIC TECHNOLOGY GMBH, Baden (CH)

(21) Appl. No.: 15/033,369

(22) PCT Filed: Oct. 10, 2014
(86) PCT No.: PCT/EP2014/071749

§ 371 Date: Apr. 29, 2016

(30) Foreign Application Priority Data
Oct. 29, 2013 (EP) 13190703.2

(51) Int. Cl. C23C 4/129; C23C 4/073; F01D 5/28; B05B 7/20

(52) U.S. Cl. CPC C23C 4/129; B05B 7/205; C23C 4/073; F01D 5/288; F05D 2220/32; F05D 2230/311; F05D 2230/90; F05D 2300/173

(57) ABSTRACT

The invention relates to a device for High Velocity Oxygen Fuel thermal spraying process for coating a component, especially a gas turbine component. The device includes a liquid fuel fired combustion chamber, a de-Laval section, a powder injector block with powder injectors and a barrel all arranged around and along an axis. The powder injector block includes at least four powder injectors arranged in an equal circumferential distance around the axis and an exchangeable hot gas section insert inside the powder injector block designed as a cylindrical bush with at least four openings, the openings being arranged in an equal circumferential distance around the axis in the cylinder, wherein the bush is fixed by the at least four powder injectors extending through said openings.

### BACKGROUND OF THE INVENTION

The present invention relates to the technology of coating components, especially of metallic components used as hot gas parts in gas turbines. It refers to a device for High Velocity Oxygen Fuel (HVOF) thermal spraying process according to the preamble of claim 1.

### PRIOR ART

The use of gas turbines (GTs) for electrical power generation can be very different in their working modus. GTs can be either used in order to produce a constant amount of electricity over a long period of time, as so-called “base loaders”, or they can be used in order to level the differences between the electricity production of rather constant sources (Nuclear, GT base loaders etc.) with addition of the variations due to the increasing amount of non-constant renewable energy and due to the non-constant electricity demand. The second type of GT is a so-called “cyclic/peaker”.

Within the lifetime of a GT it is possible that a “loader” becomes a “peaker”. This change in working conditions leads to differences in solicitations and distress modes (i.e. boundary conditions) for the components in the turbine and especially the ones subjected to extreme temperature conditions. In the case of “loaders” they will need a larger creep and oxidation resistance, and in the case of “peakers” those component will need a better cycling resistance.

Furthermore, for each component, and locally on the component, the boundary conditions are different. Some areas are more prone to fatigue and some other areas to creep, oxidation/corrosion, erosion, etc. All those properties are strongly depending on a coating that is usually used to adapt the component to the actual operational boundary conditions. In order to answer the variations in properties needed it is therefore of strong interest to be able to produce coatings with flexibly and individually tailored properties.

The applicant of the present application has filed a so far not yet published European patent application (Application number: 13160051). There is described a method for applying a coating system to a component of a turbo machine by use of at least two separate powder feeders for each separate powder which can be of either homogeneous composition or a flexible composite powder, sprayed simultaneously where the ratio of each powder can be changed online by changing the feeding rate.

Protective metallic coatings for gas turbine components, for example of the MCrAlY type (M=Fe, Ni, Co or combinations thereof) are applied by thermal spraying, whereas the HVOF spraying process is one of the most frequently used techniques for this purpose.

It is known state of the art that HVOF systems run on either gas or liquid fuels. Liquid-fuelled HVOF systems have the advantage that they produce denser coatings compared to their gas-fuelled counterparts. Therefore liquid-fuelled HVOF systems are of more technical interest.

A typical HVOF system is schematically shown in FIG. 1. The system 1 comprises a combustion chamber 2, where fuel 3 and oxygen 4 are fed in and combusted into a complex gaseous mixture 5. Then this mixture 5 is forced through a nozzle 6 (de-Laval section) which accelerates the gaseous mixture 5 to supersonic velocity within a barrel 7. Powder 8 for the coating is fed via a powder injector block either by a carrier gas into the combustion chamber 2 or downstream after the nozzle 6 into the barrel 7.

The known commercially available liquid fired HVOF burners work with only two powder injectors. This implies limitations in deposition rate, sensitivity to asymmetries in spray spot geometry (due to only 02 symmetry class), time consuming retooling in case of e.g. application of double-layer coatings, etc.

HVOF burners using gaseous fuel usually work with single powder lines and axial injection into combustion chamber. In fact, these HVOF burners e.g. have a more stable spray spot geometry, but are not suitable for the application of metallic powder of the MCrAlY type due to the strong formation of oxides in the coating layer.

The current design of the commercially available HVOF burner's powder injector block comprises a bulk design and is manufactured in one piece. At a certain level of unavoidable abrasive wears in the hot gas section of the injector block (that is caused during radial injection of the powder into the supersonic gas), the part has to be replaced or elaborately reworked. The latter is only once possible and has to be done by the manufacturer of the original powder injector block. This is expensive.

There is no commercially design known that would allow for exchange of just the degraded section of the injector block. In addition, there is no design improvement commercially available, even if the current design shows significant losses due to shocks in gas flow that are caused by non-optimized design, for example at any sudden transition in cross-section (phases and edges).

In EP 1 816 229 A1 a spraying device for HVOF is disclosed, which comprises only one powder injection line, furthermore a workpiece holder rotatable about an axis (A), a spay nozzle spraying in a spraying direction (S), wherein an angle is between (A) and (S), and a pivoting arrangement for pivoting the rotation axis (A). All regions of the circumferential surface surrounding the axis of rotation (a) face the spraying direction (S) once. With this device a good spray quality could be reached, but there is on one hand still a lot of time necessary for the coating process and on the other hand it is not possible to produce coatings with flexibly and individually tailored properties.

It would therefore be of great advantage to have an improved HVOF system/device which allows a time reduction of the spraying process compared to the known state of the art systems as well as an improved maintainability, an improved process robustness and flexibility/capability. An additional advantage is when at the same time compatibility to the existing spraying equipment could be preserved.

### SUMMARY OF THE INVENTION

It is an object of the present invention to provide a HVOF device for coating a component of a turbo machine, which allows a time reduction of the spraying process compared to the known state of the art systems as well as an improved maintainability, an improved process robustness and flexibility/capability. At the same time compatibility to the existing spraying equipment should be preserved. These and other objects are obtained by a HVOF device according to independent claim 1.

The core of the invention is that the powder injector block of the HVOF device according to the preamble of claim 1 comprises on one hand at least four powder injectors arranged in an equal circumferential distance around the axis (A) and one the other hand an exchangeable hot gas section insert inside the powder injector block designed as a cylindrical bush with at least four openings said openings arranged in an equal circumferential distance around the axis (A) in the cylinder, wherein the bush is fixed by the at least four powder injectors extending through said openings.

As an advantage, the hot gas section insert can be exchanged after unavoidable wear in a fast way without a lot of costs and without elaborately reworking.

According to the known state of the art there are commonly used two powder injection lines for liquid fuel fired HVOF thermal spraying systems. But it was identified that the maximum deposition rate during the coating process is limited by the capacity of the powder lines. When the maximum powder flow rate is reached the powder flow and with this also the flame start to pulsate and the coating process becomes instable. By using additional powder injectors (in minimum four powder injectors) which are arranged in a symmetrical way with an equal distance between each other according to the present application higher deposition rates under stable coating conditions could be reached. The spray spot geometry will become much more stable.

An additional important advantage of the present application is that the claimed hardware improvements (exchangeable gas section insert, at least four powder injectors) could be reversible implemented within a limited time into already existing devices/systems. Only alignments/modifications with respect to the machine speed/number of repetitions and the control of the powder lines are necessary. All other additional process parameter, like combustion chamber pressure, kerosine flow, oxygen flow, spraying distance, robot programs etc. have not to be changed because of the maintenance/preservation of the spray spot geometry.

According to an embodiment of the inventive device the cylindrical bush comprises a guiding groove for a definite orientation of said bush around the axis A, wherein the bush is inserted from the outside of the powder injector block.

Another embodiment of the invention is characterized in that in addition to the above-mentioned features of the powder injector block the de-Laval section has a bell-shaped design or at least a design with rounding out of edges. Without those latter mentioned improvements the current commercially available design shows significant losses due to shocks in gas flow. Shocks and therefore thermodynamic losses for standard setup could be clearly demonstrated by means of CFD (Computational Fluid Dynamic) simulations at any sudden transition in cross-section (phases and edges).

The bell-shaped de-Laval section can be combined with a cylindrical barrel. In this option, the gas reaches already the final velocity before entering the powder injector block. No further expansion is needed.

It is further possible that the bell-shaped design of the de-Laval section is combined with a full conical design of the powder injector block/barrel section.

As an advantage the claimed device is used for HVOF coating of gas turbine components, especially for applying metallic protective coatings of the MCrAlY type.

### BRIEF DESCRIPTION OF THE DRAWINGS

The present invention is now to be explained more closely by means of different embodiments and with reference to the attached drawings.

FIG. 1 shows in a simplified drawing a configuration for a HVOF thermal spraying device according to the prior art;

FIG. 2 shows a photo of the powder injector block according to the prior art with two powder injectors;

FIG. 3 shows a photo of the powder injector block according to the invention with four powder injectors;

FIG. 4 shows a schematic cut through the injector block according to a first embodiment of the invention;

FIG. 5 shows a photo of the exchangeable hot gas section device (cylindrical bush) according to an embodiment of the invention and

FIG. 6, 7, 8 show in simplified drawings three embodiments of he de-Laval section and the barrel of the device.

### DETAILED DESCRIPTION OF DIFFERENT EMBODIMENTS OF THE INVENTION

The invention uses state of the art and commercially available liquid fuel fired HVOF equipment as basis and implements several improvements regarding process stability/capabilities/maintainability. At the same time, compatibility to the existing spraying equipment is preserved.

A first feature is the application of additional powder injectors to the injector block that enables the reliable processing of higher powder feed rates, which leads to time reduction, stabilizes the spray spot geometry due to a symmetry increase and enables the simultaneous processing of different powder types with or without time consuming retooling.

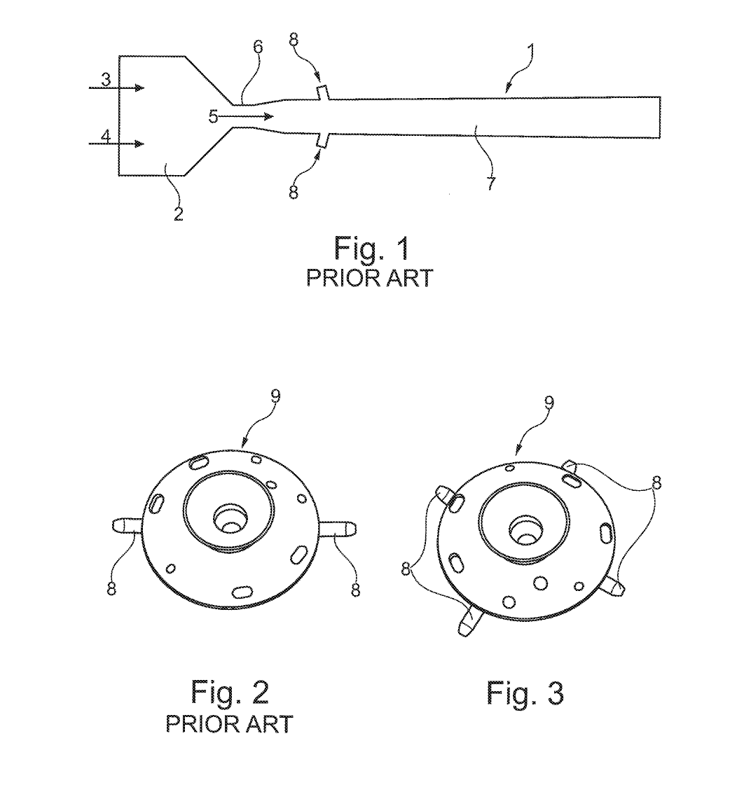

This feature is shown in FIG. 3 compared to FIG. 2. FIG. 2 is a photo of the standard powder injector block 9 according to the prior art. The two powder injectors 8 are clearly visible. FIG. 3 is a photo of the powder injector block 9 according to the invention with four powder injectors 8. The powder injectors 8 are symmetrically arranged in circumferential direction that means in an equal circumferential distance around the axis A (A is not shown in FIG. 3).

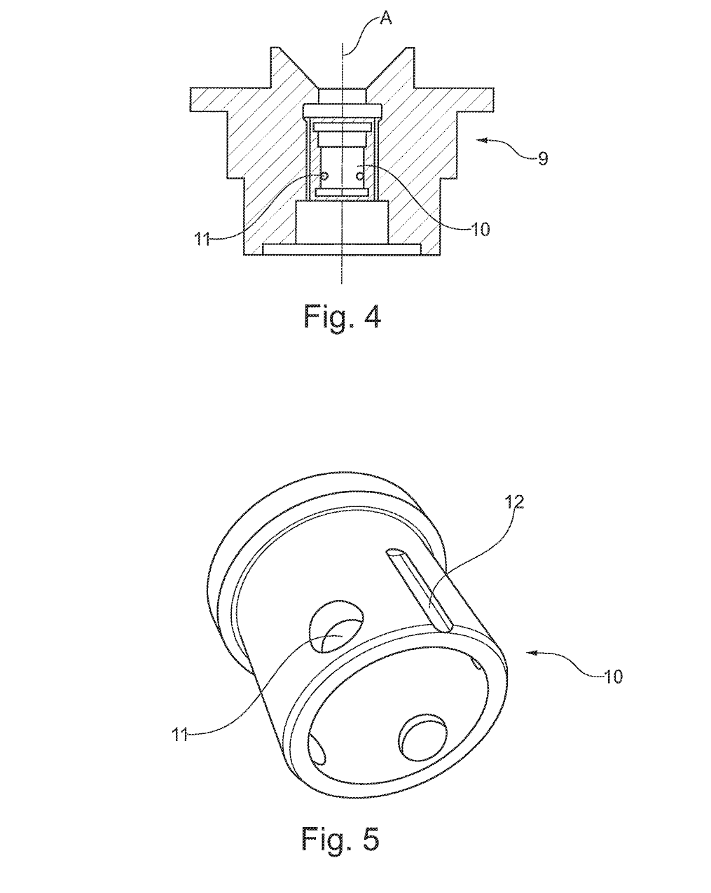

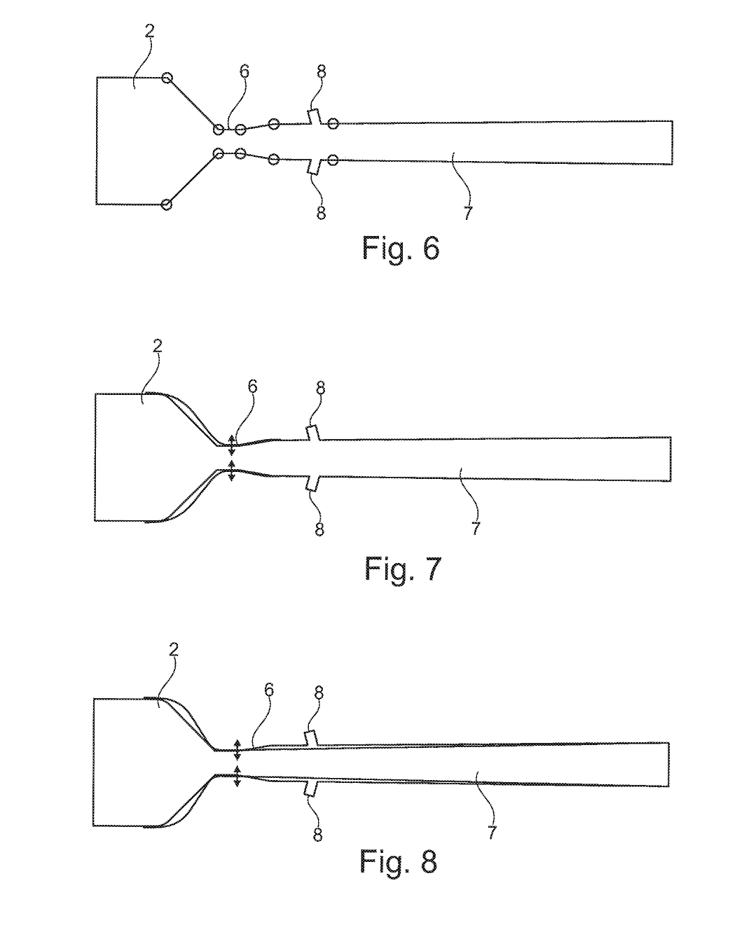

A second feature of the device according to the present invention is the arrangement of an exchangeable insert 10 into the flow section of the injector block 9 in order to reduce maintenance costs and to improve the maintainability of the HVOF burner's injector block 9. FIG. 5 shows a photo of that insert in form of a cylindrical bush 10 with openings 11 and a guiding groove 12, while FIG. 4 shows a schematic cut through the injector block 9. The openings 11 (here four) are arranged in an equal circumferential distance around the axis A (see FIG. 4) in the cylinder. The four powder injectors 8 extend through the openings 11 and fix the bush 10 in the powder injector block 9. The guiding groove 12 is the warrantor for a definite orientation of said bush 10 around the axis A. The bush 10 is inserted from the outside of the powder injector block 9 and can be exchanged in an easy way when it is necessary because of wear.

Such a prototype of a modified HVOF injector block 9 having four powder injectors 8 and an exchangeable hot gas section insert 10 was tested at an existing spraying booth of the applicant. For coating a gas turbine blade for a GT of the applicant, the deposition rate could be doubled at remaining coating quality (bonding, coating thickness distribution, porosity) resulting in about 40% lead time reduction with respect to coating the blade with a commercially available HVOF injector block. The spray spot of the modified HVOF device was found to be highly symmetric (round) even without special adjustment of carrier gas flows as usually needed for the standard setup.

The following advantages could be reached:

The modified injector block was implemented into the existing equipment within few minutes, uses the standard parameter set as well as the standard robot program (solely the amount of repetitions has needed adjustment) and obtains the same deposition efficiency when compared to the standard setup. The flame (Le. amount/distance of diamond shocks) was found to be the same for standard as well as modified injector block.

There is only a low risk for residual stresses caused crack formation in the coating at critical locations of the components due to the increases deposition rate. The implementation is not complicated. Besides possible additional powder feeders, the presented hardware modifications do not require adaption of existing spraying equipment/setup, i.e. use of the same controller/robot program/fuel/gas etc.

Of course the invention is not limited to the described embodiment, for example more than four powder injectors could be used.

In addition, CFD investigations have demonstrated the potential for design improvement of the commercial available baseline equipment with respect to losses by thermodynamic shocks. The de-Laval section 4 of the device 1 can be improved by several options, which are described as the following embodiments:

1. Removal of steps and phases in current baseline design by rounding out of edges. This option does not need time consuming CFD investigations and attenuates the thermodynamic losses by shocks resulting in slightly increased particle velocities and lower coating porosity, respectively (see FIG. 6).

2. Bell-shaped design of the de-Laval section 4 in combination with a cylindrical barrel 7. In this option, the gas reaches already the final velocity before entering the powder injector block 9. No further expansion is needed and the powder injection 8/barrel section 7 is designed cylindrically without edges and phases. The improved layout removes also the significant overexpansion at barrel 7 exit of the baseline. Less shocks and thermodynamic losses result in higher particle velocitiy and lower coating porosity, respectively (see FIG. 7).

3. Bell-shaped design of the de-Laval section 4 in combination with a full conical design of the powder injector block 9/barrel section 7. The improved layout removes also the significant overexpansion at barrel 7 exit of the baseline.

The device according to the invention is preferably used for coating gas turbine components with metallic protective coatings of the MCrAlY type.

### LIST OF REFERENCE NUMERALS

1 HVOF device

2 combustion chamber

3 fuel

4 oxygen

5 gaseous mixture, combustion gas

6 nozzle, de-Laval section

7 barrel

8 powder injector

9 powder injector block

10 hot gas section insert, cylindrical bush

11 opening

12 guiding groove

1. Device for High Velocity Oxygen Fuel thermal spraying process for coating a component, comprising:
a liquid fuel fired combustion chamber, a de-Laval section, a powder injector block with powder injectors and a barrel all arranged around and along an axis (A), wherein the powder injector block having at least four powder injectors arranged in an equal circumferential distance around the axis (A) and an exchangeable hot gas section insert inside the powder injector block configured as a cylindrical bush with at least four openings, said openings being arranged in an equal circumferential distance around the axis (A) in the cylinder, wherein the bush is fixed by the at least four powder injectors extending through said openings.

2. Device according to claim 1, wherein the cylindrical bush comprises:
a guiding groove for a definite orientation of said bush around the axis (A) and the bush is inserted from the outside of the powder injector block.

3. Device according to claim 1, wherein the de-Laval section has a bell-shaped configuration.

4. Device according to claim 3, wherein the bell-shaped de-Laval section is combined with a cylindrical barrel.

5. Device according to claim 3, wherein the bell-shaped de-Laval section is combined with a conical barrel.

6. Device according to claim 5, wherein the bell-shaped de-Laval section is combined with a full conical configuration of the powder injector block.

7. Device according to claim 1, in combination with a gas turbine component, the device being arranged for coating the gas turbine component.

8. Device according to claim 1, in combination with metallic protective coatings of the MCrAlY type for performance of a spraying process.
